(19) United States
(12) Patent Application Publication
(10) Pub. No.: US 2005/0228836 A1
(43) Pub. Date: Oct. 13, 2005

(54) Apparatus and method for backing up computer files

(76) Inventors: Steven V. Bacastow, Cumming, GA (US); Jay Regula, Miramar, FL (US); Richard Terrell, Cumming, GA (US); Mike Heuss, Alachua, FL (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/101,755

(22) Filed: Apr. 8, 2005

Related U.S. Application Data
(60) Provisional application No. 60/560,840, filed on Apr. 8, 2004.

(51) Int. Cl. G06F 17/30

(52) U.S. Cl. 707/204

(57) ABSTRACT

An apparatus and method for backing up computer files comprising a portable housing, nonvolatile memory within the housing, an interface on the housing for communication between the nonvolatile memory and the computing device, and a software application in the nonvolatile memory. Using the software application, files are designated on the computing device for backing up. Copies of the designated files are made by the application and stored in the nonvolatile memory. The software application may also be used to designate backed up files in the nonvolatile memory for restoration on the computing device. Copies of the designated files are made by the application and restored on the computing device.

### RELATED APPLICATION

This application claims the benefit of priority of U.S. provisional application Ser. No. 60/590,840, filed Apr. 8, 2004, which is relied on and incorporated herein by reference.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates to an apparatus and method for backing up computer files. More specifically, the present invention relates to an apparatus and method for backing up files from multiple computers onto a portable nonvolatile memory device using software carried in the device.

### BACKGROUND OF THE INVENTION

In recent years, personal computers (“PCs”) have become everyday necessities for people conducting business and managing their lives, whether at the office, at home, or on the road. Many people have come to depend on their PCs for communicating with others, keeping, appointments, managing finances, maintaining important records, learning new skills, and performing their jobs.

Given this dependence, it is understandable that people have used various methods to protect the files and data on their PCs in the event of computer failure, theft, or other unintentional loss of information. Such methods generally include saving a copy of the files, or “backing up” the files, onto a portable storage device, such as a floppy disk, a removable hard disk, or a nonvolatile memory device. The use of a nonvolatile memory device is typically preferred because such devices do not require a power source to retain their memory contents. In addition, such devices can provide “plug and play” capability, low power consumption, portability, and high density storage.

One drawback to conventional methods and devices is that they require the user to install and run software on the PC for performing the backup operations. Such software takes up memory on the PC and is completely dependent on the particular PC on which it resides. Moreover, conventional devices are limited in that they may only be used to backup files from a single PC. Thus, a person or family that owns several PCs must purchase multiple devices in order to backup and protect the files on each PC.

Therefore, a need exists for an apparatus and method for backing up computer files that addresses these shortcomings in the prior art.

### SUMMARY OF THE INVENTION

The present invention answers this need by providing an apparatus and method for backing up computer files that allows a user to archive files from multiple PCs to a single nonvolatile memory device using software carried by the device.

According to the present invention, a portable housing is provided with nonvolatile memory inside. An interface is provided on the housing for communication between the nonvolatile memory and the PC. A software application is loaded into the nonvolatile memory and comprises a setup utility and a backup utility. The software application can be loaded into the nonvolatile memory by the manufacturer or by the user via a CD-ROM, the Internet, or other suitable means.

Using the setup utility, the user designates the files on the PC that are to be backed up. The backup utility then makes a copy of the designated files and stores the copy of each designated file in the nonvolatile memory.

Because the software application resides on the device and not on the PC, the present invention may be used to backup files from additional PCs in the same manner.

In another embodiment of the present invention, a restore utility of the software application may be used to designate and restore files that have been backed up on the nonvolatile memory to one or more PCs.

In still other embodiments, the setup utility and backup utility can be used to schedule and perform automatic backup operations in order to automatically backup files from the PC at regular intervals or at designated instances.

It is thus an advantage of the present invention to provide an apparatus and method for backing up files from multiple computers that may be operated from and stored to a single removable storage device. To this end, the present invention is highly portable, operates independently of any particular computer station, and is compatible with a wide variety of computer stations.

Embodiments of the present invention are described below by way of illustration. Other approaches to implementing the present invention and variations of the described embodiments may be constructed by a skilled practitioner and are considered within the scope of the present invention.

### BRIEF DESCRIPTION OF THE DRAWINGS

FIG. 1 is a relational diagram showing a device for backing up computer files in accordance with the present invention.

FIG. 2 is a flow diagram of the software application installation process in an embodiment of the present invention.

FIG. 3 is a graphical user interface (“GUI”) for confirming usage of the application with a specific computing device in an embodiment of the present invention.

FIG. 4 is a GUI for selecting a computer ID for the computing device that is connected to the apparatus in an embodiment of the present invention.

FIG. 5 is a GUI for creating a password in connection with the application in an embodiment of the present invention.

FIG. 6 is a GUI for changing the password used in connection with the application in an embodiment of the present invention.

FIG. 7 is a GUI for accessing support and maintenance information in an embodiment of the present invention.

FIG. 8 is a GUI for designating the file(s) and/or folder(s) on the computing device for backing up in an embodiment of the present invention.

FIG. 9 is a flow diagram of the setup creation and designation process in an embodiment of the present invention.

FIG. 10 is a GUI for scheduling backup operations in an embodiment of the present invention.

FIG. 11 is a more detailed embodiment of a GUI for scheduling backup operations in an embodiment of the present invention.

FIG. 12 is a flow diagram of the schedule configuration process in an embodiment of the present invention.

FIG. 13 is a GUI for configuring filtering options in an embodiment of the present invention.

FIG. 14 is a GUI for initiating a backup operation in an embodiment of the present invention.

FIG. 15 is a flow diagram of the backup operation process in an embodiment of the present invention.

FIG. 16 is a GUI for designating the file(s) and/or folder(s) in the nonvolatile memory for restoring in an embodiment of the present invention.

FIG. 17 is a GUI for managing files which have been stored in the nonvolatile memory in an embodiment of the present invention.

FIG. 18 is a GUI for displaying attributes of backed up files in an embodiment of the present invention.

FIG. 19 is a GUI for confirming the deletion of backed up files in an embodiment of the present invention.

FIG. 20 is a GUI for confirming the destination of restored files in an embodiment of the present invention.

FIG. 21 is a GUI for displaying backup operation history and restore operation history in an embodiment of the present invention.

FIG. 22 is a GUI for displaying failed backup file information in an embodiment of the present invention.

FIG. 23 is a GUI for displaying failed restore file information in an embodiment of the present invention.

FIG. 24 is a GUI for configuring preference settings in an embodiment of the present invention.

FIG. 25 is a GUI for resetting the functionality of the application to default settings in an embodiment of the present invention.

### DETAILED DESCRIPTION OF THE INVENTION

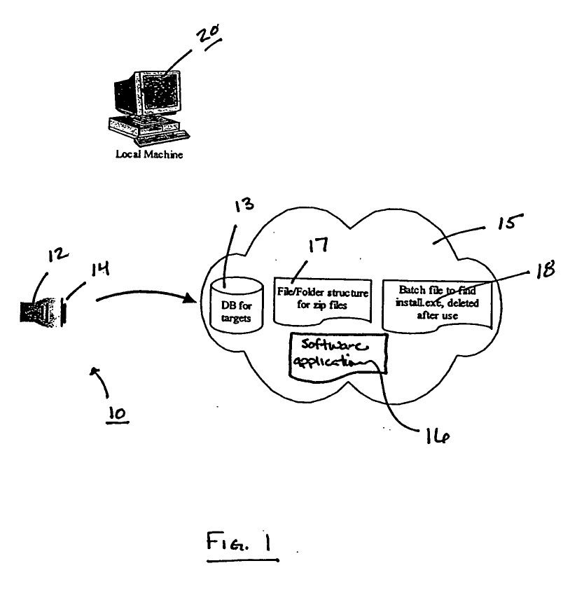

With reference to FIG. 1, a device 10 for backing up files from a computing device 20, such as a PC, in accordance with the present invention comprises a portable housing 12, nonvolatile memory 15 within the housing 12, an interface 14 on the housing 12 for communication between the nonvolatile memory 15 and the computing device 20, and a software application 16 in the nonvolatile memory 15.

In the described embodiment, the interface 14 comprises a universal serial bus (“USB”) connector. USB is a communication protocol that is well known in the art and thus is not described in detail herein. An advantageous feature of using a USB interface is that a USB device can be connected to the computing device 20 while the computing device 20 is powered on and the operating system will recognize the USB device as a removable drive and assign it a drive letter. This feature is typically referred to as “plug and play.” It will be appreciated, however, that the nonvolatile memory 15 may communicate with the computing device 20 via any suitable physical or wireless interface 14.

In certain embodiments, the capacity of the nonvolatile memory 15 can range from 256 megabytes to 2 gigabytes, but can be any capacity sufficient to store any archived files, executable code, and/or other information desired.

Installation of the Software Application.

In one embodiment, the software application 16 is provided to the user in the nonvolatile memory 15. For example, the user may purchase or obtain the device 10 from a manufacturer or retailer with the software application 16 preloaded into the nonvolatile memory 15. In accordance with this embodiment, the user installs the software application 16 by accessing the root for the device 10 (conventionally the E: drive or F: drive) and double clicking on a installation executable file 18, or otherwise causing the file 18 to run.

In other embodiments, the software application 16 is not preloaded into the nonvolatile memory 15 and the user obtains the software application 16 separately from the device 10. For example, the user may obtain the software application 16 on a CD-ROM or other storage medium, or by downloading it from another device via a local or wide area network. In accordance with these embodiments, the user locates the installation executable file 18 on the computing device 20, storage medium, or any other device on which it is maintained. The user then runs the installation executable file 18 by double-clicking on the file 18 or by other means.

Upon running the installation executable file 18, the user is provided with certain instructions for installing the software application 16 as is known in the art.

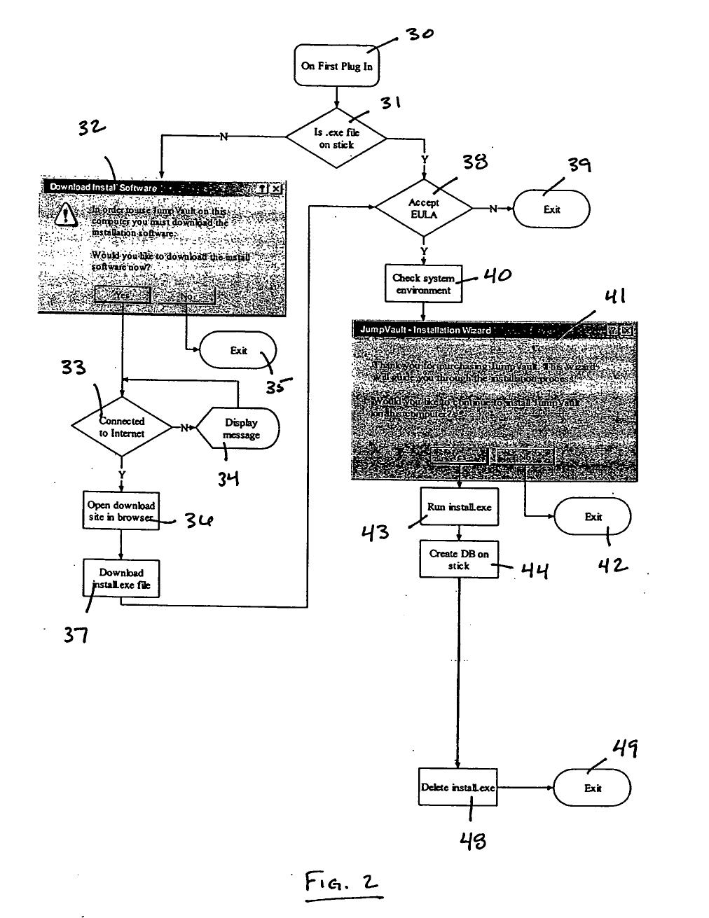

With reference to FIG. 2, an embodiment of the installation process will be described. At step 30 the user establishes communication between the nonvolatile memory 15 and the computing device 20 by, for example, plugging the USB interface 14 into a USB port on the computing device 20. At step 31, the user confirms that the software application 16 is available in the nonvolatile memory 15 of the device 10. If the software application 16 (including the installation executable file 18) was provided in the nonvolatile memory 15, the user proceeds directly to step 38 (described below).

If the installation executable file 18 is to be obtained via another means, such as a network (e.g., the Internet), a CD-ROM, or other storage medium, the user instead proceeds to step 32 and provides input via a GUI as to whether he or she would like to download the file 18 at the current time. If not, the process exits at step 35, whereby the user may proceed to install the software via a CD-ROM or other storage medium. If so, the user is connected to the network at step 33, accesses the appropriate website or other location on the network where the file 18 may be obtained at step 34, downloads the installation executable file 18 at step 37, then proceeds to step 38.

At step 38, the user is presented with an end user license agreement (“EULA”) relating to the software application 16. If the user disagrees with the terms of the agreement, the process exits at step 39. If the user agrees with the terms of the agreement, the application 16 checks the system environment at step 40 and requests input from the user via a GUI at step 41 to determine whether the user would like to continue to install the application 16 on the current computing device 20. If the user does not wish to continue installing the application 16 on the current computing device 20, the process exits at step 42. If the user does wish to continue, the installation executable file is run at step 43.

Upon running the installation executable file 18 at step 43, the application 16 creates a relational database 13 (FIG. 1) and a file structure, or database schema, 17 (FIG. 1) in the nonvolatile memory 15 of the device 10 at step 44.

Finally, the application 16 deletes the installation executable file 18 at step 48 and exits the process at step 49.

The software application 16 of the present invention is designed to be installed in the nonvolatile memory 15, not on a drive of the computing device 20 or other networked drive. Once the device 10 is installed, the user may run the software application 15 by accessing the root for the device 10 (conventionally the E: drive or F: drive) and by double clicking on a application executable file, or otherwise causing the file to run.

In an embodiment of the present invention, once the application 16 has been installed the application executable file is automatically run upon each subsequent establishment of communication between the nonvolatile memory 15 and the computing device 20. In order to enable the “Auto-Start” functionality, the user must restart the computing device 20 after the first use of the software 16. Restarting the computer device 20 will also cause a shortcut to the software application 16 to be placed on the computing device 20.

Activation of the Computing Device.

In embodiments of the present invention, the software application 16 is configured to track each computing device used in connection with the application 16 and to automatically catalogue and organize, by a computer ID and a user ID, all backed up files from all associated computing devices. In accordance with these embodiments, the application 16 is configured to recognize each computing device by its associated computer ID upon connection with the device 10. Also in accordance with these embodiments, the application 16 may be configured to write to the registry of the computing device 20 during installation of the application 16 and read from the registry in the event of a second installation of the application 16.

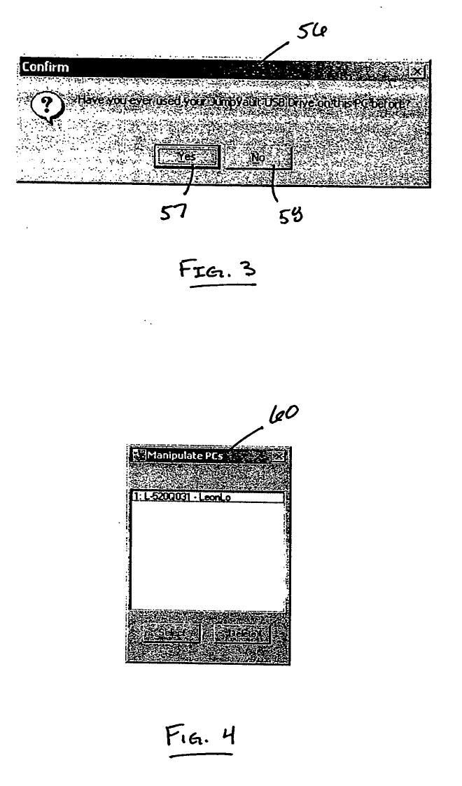

With reference to FIG. 3, in certain of these embodiments, each time a new version of the software application 16 is run for the first time in connection with a particular computing device 20, the application 16 requests input from the user via a confirmation GUI 56 to confirm that the application 16 has been used in connection with the presently connected computing device 20.

Selecting a Yes button 57 on the confirmation GUI 56 causes the application 16 to assign the presently connected computing device 20 a computer ID and to activate the presently connected computing device 20 as a designated computing device for the various functionality of the application 16. Selecting a No button 58 on the confirmation GUI 56 causes the application 16 to present the user with a PC manipulation GUI 60, as shown in FIG. 4, for selecting a computer ID.

Synchronization Utility.

In an embodiment of the present invention, the software application 16 further comprises a synchronization utility to assist the user in synchronizing files on more than one computing device 20 used in connection with the device 10. Once the user has used the application 16 in connection with more than one computing device 10, the synchronization utility prompts the user to select the computing devices for synchronization. The synchronization utility is configured to track the files backed up from the first computing device selected for synchronization and to notify the user when the device 10 is connected to the second computing device selected for synchronization so that the user may synchronize the files on the first and second computing devices. In one such embodiment, a PC synch button is provided which is activated when the device 10 is connected to the second computing device.

Password Utility.

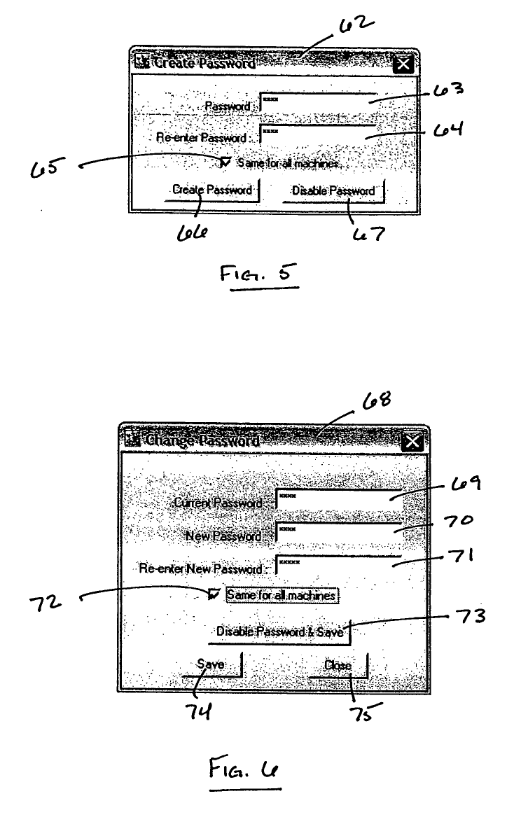

In an embodiment of the present invention, the software application 16 comprises a password utility for providing a password protection capability to the device 10. With reference to FIG. 5, the first time the software application 16 is run in connection with a particular computing device 20, the password utility presents the user with a create password GUI 62 for selecting a password to use in connection with the application 16. The user enters a password into a password field 63 and confirms the password by re-entering it into a re-enter password field 64. The user may then select a create password button 66 which causes the password utility to store the password in the nonvolatile memory 15.

Thereafter, each time the application 16 is run, the password utility will present the user with a password GUI for authentication and will prevent the user from accessing the application 16 if the password entered by the user via the password GUI does not match the password stored in the nonvolatile memory 15.

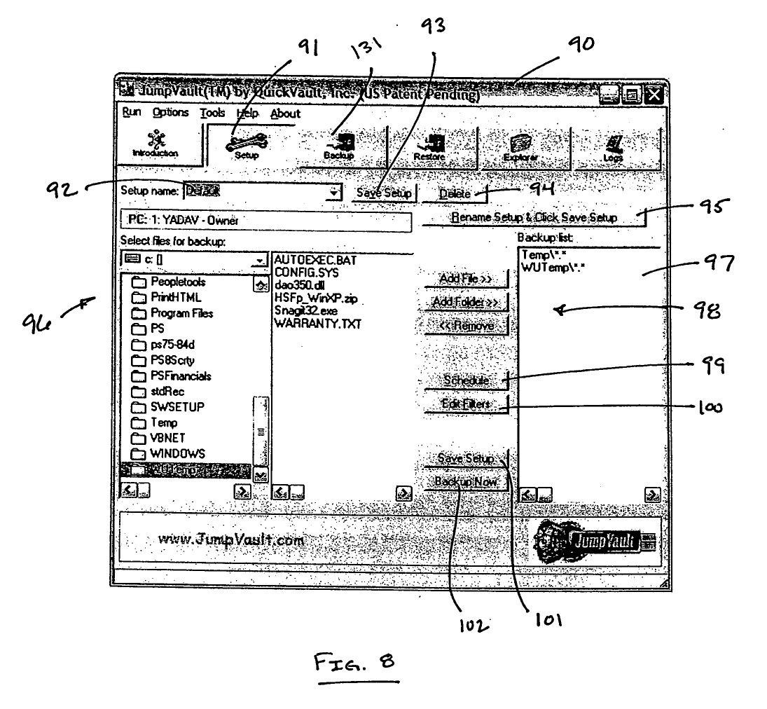

In one such embodiment, the user has the option of creating a different password for each computing device 20 or of using the same password for all computing devices 20. To create a universal password, the user selects an all machines button 65 on the create password GUI 62 before selecting the create password button 66, which will cause the password utility to associate and enforce the password stored in the nonvolatile memory 15 with every computing device 20 used in connection with the device 10. In another such embodiment, the user can disable the password protection functionality by selecting a disable password button 67 on the create password GUI 62. The password functionality can later be re-activated by re-accessing the create password GUI 62 via a options menu item 85 (FIG. 7).

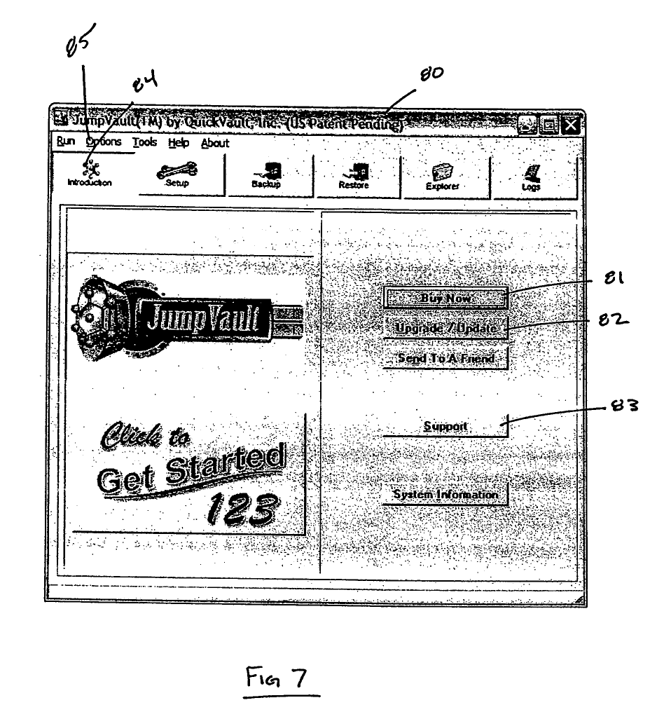

With reference to FIG. 6, the password utility may be further configured to allow the user to change the password via a change password GUI 68. The change password GUI 68 is accessed by the user via the options menu item 85 (FIG. 7). Using the change password GUI 68, the user enters the password into a current password field 69, enters a new password into a new password field 70, and confirms the new password by re-entering it into a re-enter new password field 71. The user may then select a save button 74 which causes the password utility to store the new password in the nonvolatile memory 15. As similarly described above, the user may select an all machines button 72 on the change password GUI 72 to associate and enforce the new password with every computing device 20 used in connection with the device 10 and/or temporarily disable the password protection functionality from the change password GUI 68 by selecting a disable and save button 73.

Introduction GUI.

With reference to FIG. 7, in an embodiment of the present invention, the application 16 further comprises an introduction GUI 80 for providing the user with information relating to support and maintenance of the application 16 and device 10. The user may access the introduction GUI 80 via a introduction button 84. The introduction GUI 80 includes a buy now button 81 for providing information relating to registration of the application 16 with the manufacturer, an upgrade/update button 82 for providing information relating to software upgrades or updates of the application 16, and a support button 83 for providing information relating to customer service for the application 16 and device 10. In certain embodiments, the application 16 is configured to provide the user with a text box when the user rolls his or her mouse cursor over the various GUI buttons of the present invention, such as the buy now button 81, the upgrade/update button 82, and/or the support button 83 of the information GUI 80. The text box contains information related to the functionality of the button to assist the user in making decisions and reduce the need for customer support.

Setup Utility.

With reference to FIG. 8, in accordance with the present invention the application 16 comprises a setup utility for accepting input via a setup GUI 90 to designate the files and/or folders on the computing device 20 that are to be backed up. The user may access the setup GUI 90 via a setup button 91.

The software application 16 tracks backup operations by grouping the files and/or folders designated from the computing device 20 into batches, hereinafter referred to as “setups.” It will be appreciated that one batch, or one setup, may comprise a single file or a single data set from the computing device 20 or it may comprise multiple files, data sets, folders, and/or directories, or any combination thereof, from the computing device 20.

Using a selection tool 96 on the setup GUI 90, the user designates the file(s) for backing up by browsing the memory of the computing device 20 and selecting certain files and/or folders or by entering the name of a specific file or folder. The user then adds the selected files and/or folders to a backup list 97 using selection buttons 98. The designated files and/or folders in the backup list 97 are to be included in the setup. The user may then choose a setup name for the setup using a setup name field 92 and then save the setup by selecting one of the save setup buttons 93 or 101.

In other embodiments, the setup utility is configured to allow the user to search for files on the computing device 20 by accepting characters and terms from the user, such as partial or complete file names or file extensions, wildcard truncating characters, date created information, and/or date modified information via the setup GUI 90 and performing a search of the memory of the computing device 20 to locate files that match the search criteria. The searching functionality of the setup utility may include special settings that exclude or include search terms, so as to not perform an operation on unnecessary files.

In another embodiment, the setup utility is configured to locate specific files on the computing device 20 based on file type or attributes and automatically group such files into default setups. For example, the setup utility may be configured to locate all Microsoft Word files on the computing device 20 and create a default Microsoft Word setup. Similarly, the setup utility may be configured to read the registry of the computing device 20 to locate all device driver files and/or all installed software application files and create a default device driver setup and/or a default software application setup. The user may select such a default setup using a pull-down menu on the setup name field 92.

Rather than create a new setup, if the user has previously created a setup, he or she may select the old setup by selecting the name of the previously created setup from the pull-down menu on the setup name field 92. Selecting the previously created setup will cause the setup utility to automatically populate the backup list 97 with the files and/or folders which make up the previously created setup.

In other embodiments, the setup utility is further configured to delete previously created setups when the user selects a delete button 94 and to rename previously created setups when the user selects a rename button 95 on the setup GUI 90.

In still other embodiments, the setup utility provides a notification to the user when the user selects or searches for files that may cause problems, such as files that may cause a backup failure due to a lack of available storage capacity in the nonvolatile memory 15. For example, the user may receive a notification and be cautioned against selecting or searching for backup swap files, system work files, temporary work files, or internet files.

In further embodiments, the setup utility determines the amount of available storage capacity in the nonvolatile memory 15 and provides a notification to the user when the user selects files having a total size that is greater than the available storage capacity in the nonvolatile memory 15.

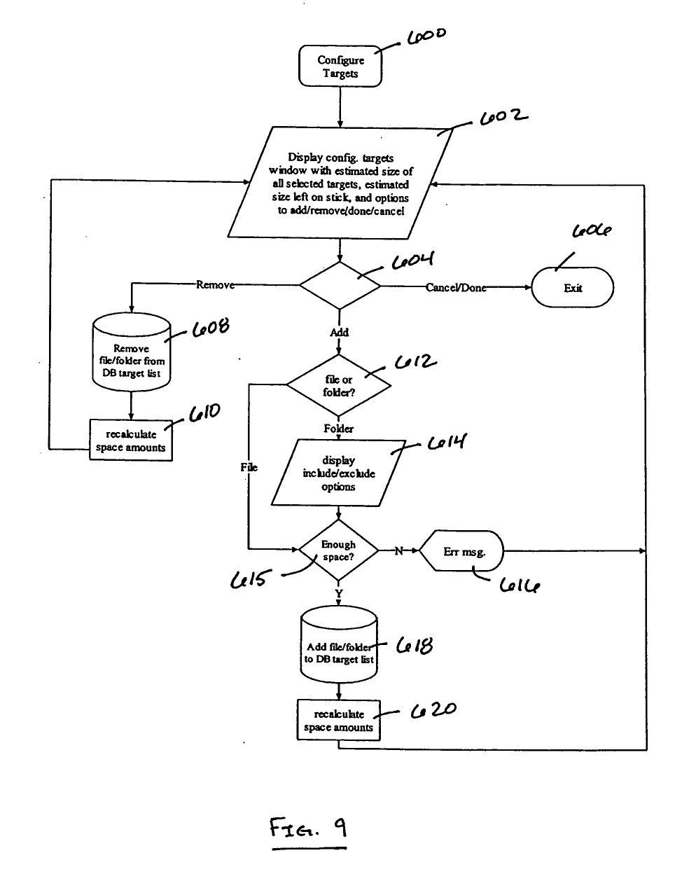

With reference to FIG. 9, an embodiment of the setup creation and designation process will be described. At step 600 the user accesses the setup GUI 90 and, at step 602, is provided with the selection tool 96 and other options previously described. At step 604, the user chooses whether to remove or add a file/folder to a setup, or to simply exit the process. If the user chooses to exit the process, a cancel button is selected and the process exits at step 606.

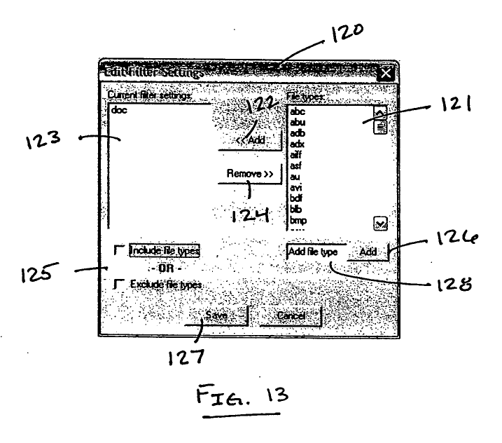

If the user chooses to add a file or folder to a setup, the user proceeds to step 604 and selects a file or folder on the computing device 20 using the selection tool 96. If a folder is selected, the setup utility provides the user with a filter settings GUI 120 (FIG. 13) which accepts input from the user to exclude certain files in the folder from designation by filtering them out and not adding them to the backup list 97 (FIG. 8) or setup. Such filtering functionality is described in greater detail below. Once the filter settings are configured, the process proceeds to step 615. If at step 612 the user selected a file, the process proceeds directly to step 615.

At step 615, the setup utility determines the amount of available storage capacity in the nonvolatile memory 15 and the total size of the files designated so far. The setup utility also determines whether the total size of the designated files exceeds the available storage capacity in the nonvolatile memory 15 and if so, provides the user with a notification at step 616. If there is sufficient capacity in the nonvolatile memory 15 to backup the designated files, the setup utility adds the file or folder selected at step 612 to the relational database 13 (FIG. 1) in the nonvolatile memory 15. The setup utility then recalculates the available storage capacity at step 620 and loops back to step 602.

If, at step 604, the user chooses to remove a file or folder from a setup, the user selects a file or folder from the backup list 97 and selects a remove button. The setup utility then removes the file or folder from the setup at step 608. The setup utility then recalculates the available storage capacity at step 610 and loops back to step 602.

It will be appreciated that the foregoing procedure may be used to add or remove several files and/or folders to a setup before exiting the process at step 606.

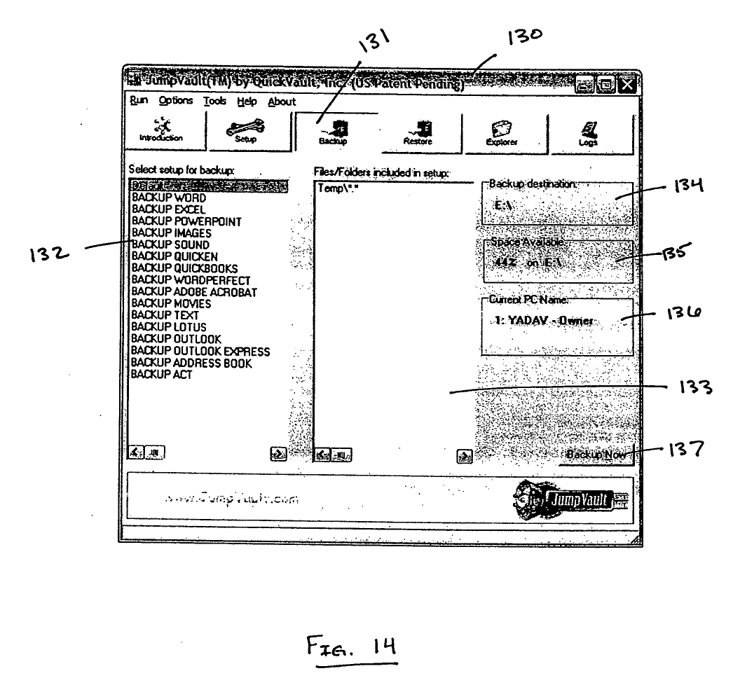

With returning reference to FIG. 8, once the user has created a new setup, selected a previously created setup, or selected a default setup, the user may initiate a backup operation to backup the file or files included in the setup by clicking a backup now button 102 or by proceeding to a backup GUI 130 (FIG. 14) via a backup button 131. The backup GUI 130 and backup operation functionality is described in further detail below.

Configuring Destinations.

In embodiments of the present invention, the user may designate the location, such as folder or sub-folder, in the nonvolatile memory 15 where the backup copy of each file from the computing device 20 is stored. Such locations in the nonvolatile memory 15 are referred to as “destinations.” Destinations may be date and time stamped and may be encrypted if so configured by the user in the configurations settings.

Scheduling Backup Operations.

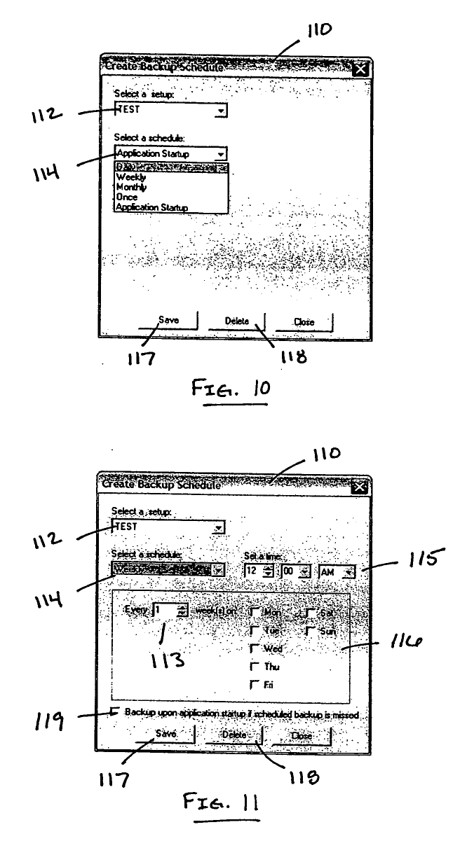

In additional embodiments, the setup utility is configured to allow the user to schedule backup operations to automatically backup setups at a regular interval or at a specific instance. The user may access such functionality by clicking on a schedule button 99 on the setup GUI 90 (FIG. 8) which causes the application 16 to present the user with a schedule GUI 110 as shown in FIG. 10.

The schedule GUI 110 accepts input from the user to designate a regular interval or a specific instance for backing up a setup. First, the user selects a setup from a drop-down menu at a setup name field 112. Then, the user designates a regular interval, such as daily, weekly, or monthly, or a specific instance, such as a one-time backup or upon startup of the application 16, from a drop-down menu at a schedule field 114. Once a setup and an interval or instance is selected, the schedule GUI 110 provides the user with specific scheduling options related to the chosen interval or instance. For example, with reference to FIG. 11, if the user has designated a weekly interval for backing up a particular setup, the schedule GUI 110 allows the user to designate a specific time via a time field 115, a specific day via a day field 116, and a specific number of weeks via a week field 113 for performing the backup operation on the chosen setup. It will be appreciated that similarly appropriate specific options are presented to the user when a daily or monthly interval, or a one-time or on startup instance, is designated.

After configuring a schedule using the schedule GUI 110, the user may select a save button 117 which causes the setup utility to create and store the schedule for the chosen setup. The user may later delete the schedule by selecting a delete button 118 or modify the schedule by returning to the schedule GUI 110 and modifying the schedule options.

In one embodiment of the present invention, the application 16 is further configured to determine when one or more of the scheduled backup operations was missed, e.g., when a backup copy of the designated file(s) from the computing device 20 was not made because the device 10 was not connected to the computing device 20 at the time scheduled for the backup operation. In this embodiment, the user may select a missed schedule checkbox 119 on the schedule GUI 110 which was cause the application 16 to automatically backup the setup for which the scheduled backup operation was missed the next time the application 16 is run, i.e., upon establishment of communication between the nonvolatile memory 15 and the computing device 20.

In another embodiment of the present invention, a log of schedule changes is maintained to aid in providing customer support to the user. One example of such a log is shown in Table 1, below.

TABLE 1

| Folder/File Name | Schedule I | Schedule II | Comment |
|---|---|---|---|
| My Documents | Daily 5:00 AM | LOM 5:00 AM | “Last Day of |
| | | | Month” |
| SmithLetter.doc | EOM | Daily 5:00 AM | “End of Month” |

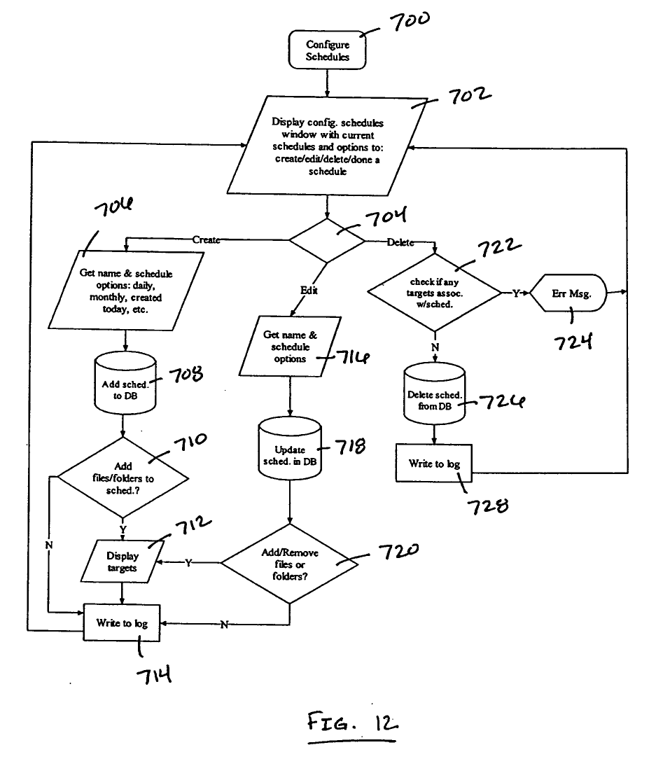

With reference to FIG. 12, an embodiment of the schedule configuration process will be described. At step 700 the user accesses the schedule GUI 110 and, at step 702, is provided with the fields previously described. At step 704, the user chooses whether to create, edit, or add a schedule.

If the user chooses to create a schedule, the user proceeds to step 706 and selects a setup from the setup name field 112 and configures the schedule as previously described. The setup utility then adds the schedule to the relational database 13 (FIG. 1) in the nonvolatile memory 15 at step 708. At step 710, the setup utility presents the user with the option to add additional files or folders to the schedule. If the user chooses to add additional files or folders to the schedule, the setup utility accepts input from the user at step 712 to designate the files or folders as previously described. The setup utility then writes the new schedule information to the log at step 714. If the user chooses not to add additional files or folders to the schedule, the setup utility proceeds directly to step 714 and writes the new schedule information to the log.

From step 714, the process loops back to step 702.

If, at step 704, the user chooses to edit an existing schedule, the user proceeds to step 716 and selects a setup from the setup name field 112 and edits the previously created schedule for that setup. The setup utility then updates the schedule in the relational database 13 (FIG. 1) in the nonvolatile memory 15 at step 718. At step 720, the setup utility presents the user with the option to add additional files or folders to the schedule. If the user chooses to add additional files or folders to the schedule, the setup utility accepts input from the user at step 712 to designate the files or folders as previously described. The setup utility then writes the new schedule information to the log at step 714. If the user chooses not to add additional files or folders to the schedule, the setup utility proceeds directly to step 714 and writes the new schedule information to the log.

From step 714, the process loops back to step 702.

If, at step 704, the user chooses to delete an existing schedule, the user selects a setup from the setup name field 112 and, at step 722, the setup utility determines whether any files/folders are associated with the schedule. If any files/folders are associated with the schedule, the setup utility provides the user with a notification at step 724. If there are no files/folders associated with the schedule, the setup utility deletes the schedule from the relational database 13 (FIG. 1) in the nonvolatile memory 15 at step 726. At step 728, the setup utility writes the schedule information to the log and loops back to step 702.

It will be appreciated that the foregoing procedure may be used to create, edit, and/or delete several schedules before exiting the process.

Filtering Files.

Returning to FIG. 8, when the user utilizes the selection tool 96 on the setup GUI 90 to designate a folder for backing up, the setup utility may be further configured to automatically exclude certain files in the folder from designation by filtering them out and not adding them to the backup list 97 or setup. The user may configure the filter settings by selecting an edit filters button 100 on the setup GUI 90 which causes the application 16 to present the user with a filter settings GUI 120 as shown in FIG. 13.

With reference to FIG. 13, the filter settings GUI 120 accepts input from the user to configure the settings of the setup utility's filtering functionality. A file type list box 121 is provided from which the user may select one or more file types by file extension or other means. Once the file type is selected, the type may be added to a filter settings list box 123 using an add button 122. Alternatively, a file type may be added to the filter settings list box 123 by entering the file extension or file name into a file type field 128 and selecting a second add button 126. In other embodiments, the filter settings GUI 120 is configured to provide the user with a list of software names and associated file types to assist the user in selecting one or more file types. In accordance with these embodiments, the user may select a software name to add a known software application to the filter settings list box 123 or select a file type associated with the software name to add all files of the selected file type to the filter settings list box 123. The file type may be removed from the filter settings list box 123 using a remove button 124.

After the user has selected the desired file types and included these types in the filter settings list box 123, the user may designate to include the selected file types in setups or exclude the selected file types from setups using an include/exclude option 125. Once the filtering settings have been configured using the filter settings GUI 120, the user may select a save button 127 which causes the setup utility to create and store the filter. Thereafter, when the user selects a folder from the computing device 20 for backing up using the setup GUI 90 (FIG. 8), the setup utility is configured to automatically include or exclude, depending on the chosen option, the selected file types from the backup list 97 and setup being created. In other embodiments, an add folder without filters button is provided to allow the user to opt-out of the filtering functionality. In still other embodiments, the filter settings may be configured for one specific folder or for one specific setup.

Backup Utility.

In accordance with the present invention, the application 16 comprises a backup utility for making a copy of the designated file(s)/folder(s) from the computing device 20 and storing the copy of the designated file(s)/folder(s) in the nonvolatile memory 15. With reference to FIG. 14, a backup GUI 130 is provided for manually initiating a backup operation. The backup GUI 130 may be accessed via a backup button 131.

In a setup field 132, the backup GUI 130 presents the user with a list of all the setups which have been created. Selecting one of the listed setups causes a file/folder list 133 to display each file and folder in the selected setup. To perform a backup operation, the user selects a setup from the setup field 132 and clicks on a backup now button 137. As shown in a destination field 134, the root destination of the files resulting from the backup operation is always in the nonvolatile memory 15 of the device 10.

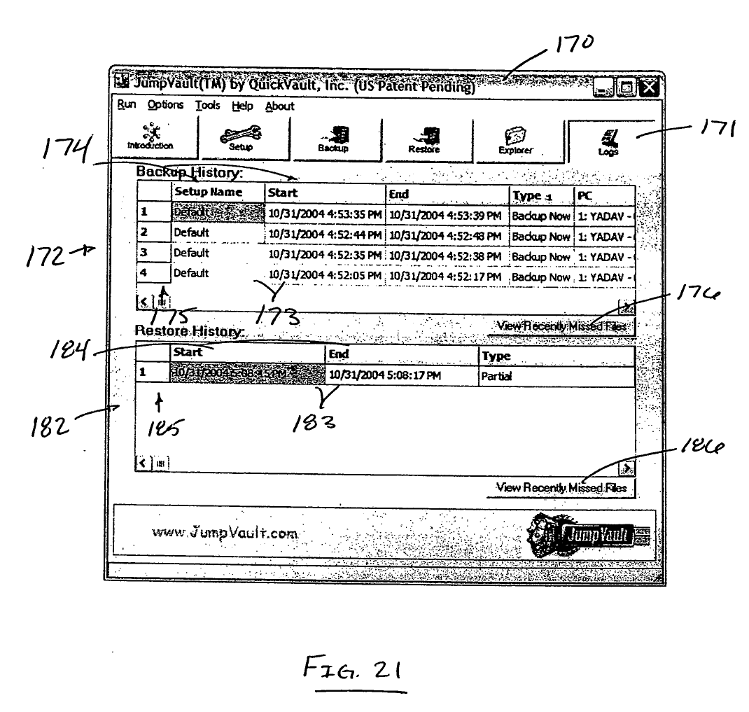

The backup GUI 130 may also display the amount of available storage capacity in the nonvolatile memory 15. In one embodiment, the backup utility is configured to determine the size of the files and/or folders in the chosen setup and provide the user with a notification when the designated files will exceed the available storage capacity of the nonvolatile memory 15. If the user attempts to backup the designated files despite the notification, the user may proceed to a log GUI 170 (FIG. 21) and select a view missed backup files button 176 to determine which files were not successfully backed up into the nonvolatile memory 15 (discussed in further detail below).

In another embodiment, when the nonvolatile memory 15 has reached its capacity or cannot perform the requested backup operation as a result of the lack of capacity, the backup utility prompts the user to designate an “off-site” destination for storing the backup files. In such an embodiment, the user has the option of directing the next backup operation, or any subsequent backup operations, to store the copy of the designated files on an offsite, or auxiliary, storage medium. Using the restore utility, explained in further detail below, the user has the option to restore the backed-up data from the offsite destination to the computing device 20 or another computing device. In other embodiments, an offsite backup destination may be designated regardless of the capacity of the nonvolatile memory 15.

In an embodiment of the present invention, the software application 16 further comprises a compression utility for compressing the copy of the designated files made by the backup utility. Thus, each backup operation results in a compressed file created from the copies of each designated file. The compressed file is then stored in the nonvolatile memory 15. Accordingly, if more than one backup operation is performed during a single day, then multiple compressed files are stored and tracked in the nonvolatile memory 15.

In another embodiment of the present invention, the software application 16 further comprises an encryption utility. In this embodiment, each compressed file is stored in an encrypted, date-stamped folder in the nonvolatile memory 15.

In other embodiments, attributes of the designated files and compressed files are written to a file table in the relational database 13 in the nonvolatile memory 15. Such attributes may include the filename, compressed filename, and/or the destination folder. The main index key to the file table is the filename (of the original file on the computing device 20) along with the date and time stamp information. In this manner, the present invention stores various versions of the same filename. The file table may also include the user ID information associated with each backup operation and file. Thus, one may distinguish between multiple users of the same computing device 20, which is important where separate setups have not been created for each user and user id. One embodiment of the file table is shown as Table 2, below.

TABLE 2

| Filename | Date & Time | Size | PC ID | USERID | ORIG |
|---|---|---|---|---|---|
| CSPRELAUNCH | 200311200401 | 400 | laptop | RT | FILE |
| CSPRELAUNCH | 200311202130 | 652 | -laptop | RT | FILE |
| CSPRELAUNCH | 200311210423 | 851 | laptop | RT | FILE |
| CSPRELAUNCH | 200311202015 | 586 | desktop | AW | MAIL |

With reference to FIG. 15, an embodiment of the backup operation process will be described. At step 800, the backup operation is initiated, either automatically according to a schedule or manually via the backup GUI 130 or setup GUI 90 as previously described. At step 802, the backup utility selects all of the files which are stored in the relational database 13 as part of the setup. At step 804, the backup utility gets one of the designated files and, at step 806, adds the file to a compressed file, also known as a “zip file.” “Zipping” is a method known in the art of compressing a file or multiple files into a single file or archive (a zip file) so that the file or files take up less memory space. “Unzipping” the zip file is the method of extracting and decompressing the zip file to reconstruct the file or files to their original uncompressed state. At step 808, the backup utility determines whether there are additional files in the setup. If there are additional files, the backup utility loops back to step 804 to get the next file in the setup. When there are no additional files in the setup, the backup utility proceeds to step 810 where the compressed file is compressed using the compression utility and the compressed file is stored in the nonvolatile memory 15. Lastly, the backup utility writes the backup information to the log at step 812, notifies the user of the successful backup operation at step 814, and ends the process at step 816.

In other embodiments, the backup utility is configured to perform a backup operation for an open document upon selection of shortcut keys, or “hot keys,” i.e., a combination of keys on the keyboard of the computing device 20 that, when pressed at one time, perform a task more quickly than by using a mouse or other input device.

Restore Utility.

With reference to FIG. 8, in accordance with another embodiment of the present invention, the application 16 comprises a restore utility for accepting input via a restore GUI 140 to designate files and/or folders on the nonvolatile memory 15 for restoring onto the computing device 20. In addition, the restore utility is configured to make a copy of the designated file(s) and/or folder(s) from the nonvolatile memory 15 and store the copy of the designated file(s) and/or folder(s) on the computing device 20. The user may access the restore GUI 140 via a restore button 141.

In a setup field 142, the restore GUI 140 presents the user with a list of all the setups which have been created. Selecting one of the listed setups causes a file/folder list 143 to display each file and folder in the selected setup. To perform a restore operation, the user selects a setup from the setup field 142 and clicks on a restore now button 149. As shown in a restore options field 145, the root origin of the files being restored is always in the nonvolatile memory 15 of the device 10.

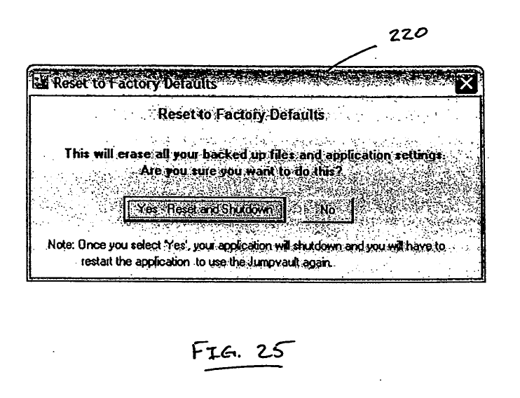

In other embodiments, the restore utility allows the user to specify the destination on the computing device 20 or other networked device where the restored file(s) are to be stored by entering a destination (e.g., a valid drive and folder location) in a restore destination field 146 or by browsing the memory of the computing device 20 or other networked device for a destination via a browsing button 147. A default destination may be specified by the user via the options menu item 85 (FIG. 7) and a preferences GUI 200 (FIG. 24), as described in further detail below.

In still other embodiments, the restore utility allows the user to choose which version of the files in the nonvolatile memory he or she wishes to restore using a revision drop-down menu 148.

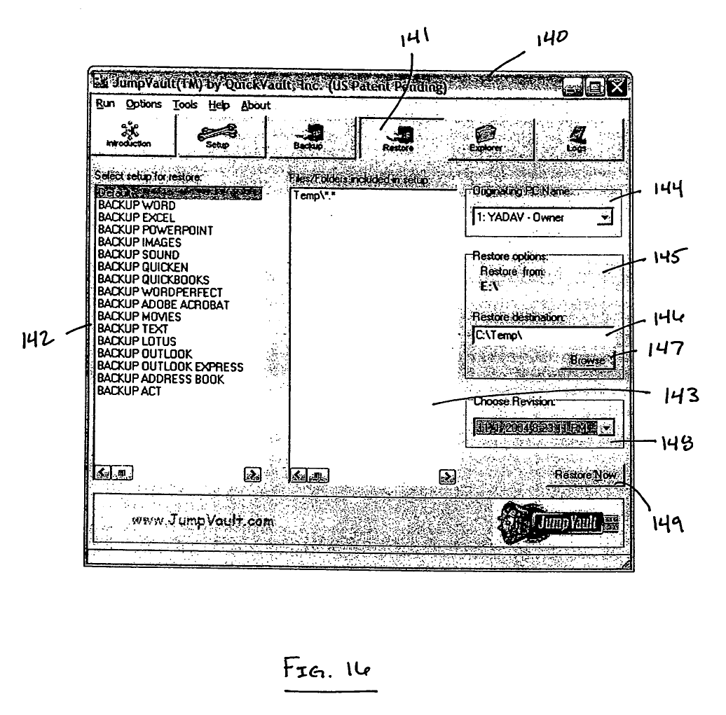

A restore operation performed from the restore GUI 140 results in the restoration of all of the files and/or folders associated with the selected setup. To restore only certain files or folders in a setup, the user may use the explorer GUI 150 (FIG. 17), which is explained in further detail below.

Explorer Utility.

With reference to FIG. 17, in accordance with another embodiment of the present invention, the application 16 comprises an explorer utility for managing the files that have been stored in the nonvolatile memory 15. The explorer utility is configured to provide attributes of backed up files, delete backed up files, open backed up files, and associate comments from the user with backed up files. The user may access an explorer GUI 150 via an explorer button 151.

The explorer GUI 150 comprises a spreadsheet 152 which functions in a manner similar to a spreadsheet utility, such as Microsoft Excel, in that the user may sort cells 153 of data by clicking on column headers 154. Further, the user may select one or more rows of the spreadsheet 152 by selecting one or more left-most column fields 155. The user may also add and edit text to the spreadsheet 152 in cells under a comments column. Associating comments with the files aids the user in managing and organizing the files in the nonvolatile memory 15. Shortcut operations known in the art, such as <CTRL+PGUP/PGDN> and <CTRL+MOUSE CLICK>, are also enabled in the spreadsheet 152.

The explorer GUI 150 may also include a display contents button 156 for displaying attributes of the file selected on the spreadsheet 152. Such attributes may be displayed in a contents GUI 160 as shown in FIG. 18.

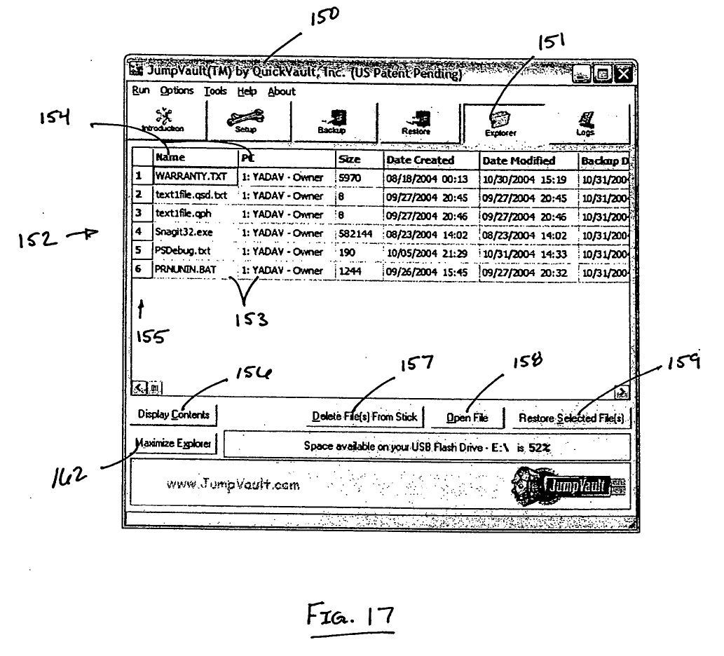

A delete files button 157 may also be provided on the explorer GUI 150 which causes the explorer utility to delete the backed up file selected on the spreadsheet 152 from the nonvolatile memory 15. The delete files button 157 aids the user by deleting files in the nonvolatile memory 15 that the user no longer needs in order to make more space available on the device 10. To delete a file, the user selects one or more of the left-most column fields 155 to select one or more files and clicks the delete files button 157. A confirmation GUI 164 as shown in FIG. 19 may be provided to the user to confirm the delete operation before the explorer utility removes the files from the nonvolatile memory 15.

The explorer GUI 150 may also include an open file button 158 for pre-viewing the file selected on the spreadsheet 152, which may be encrypted, without restoring the file to the computing device 20. The user simply selects a file from the spreadsheet 152 and selects the open file button 158 to view the actual file.

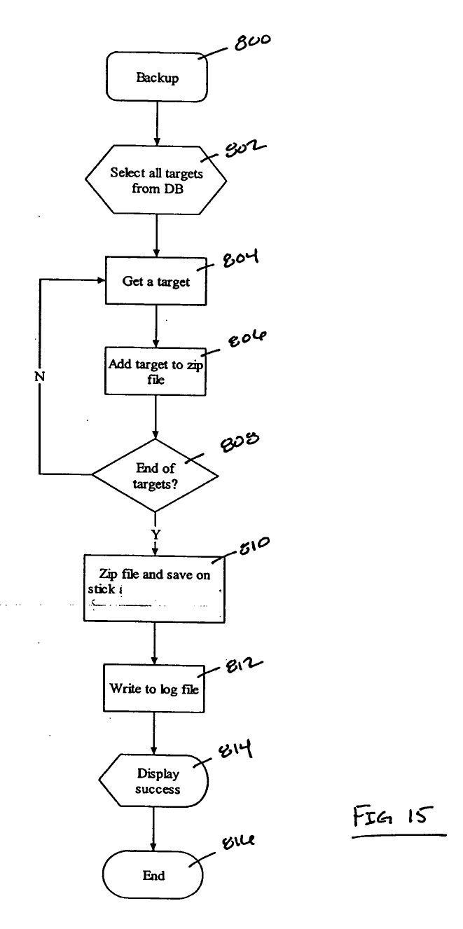

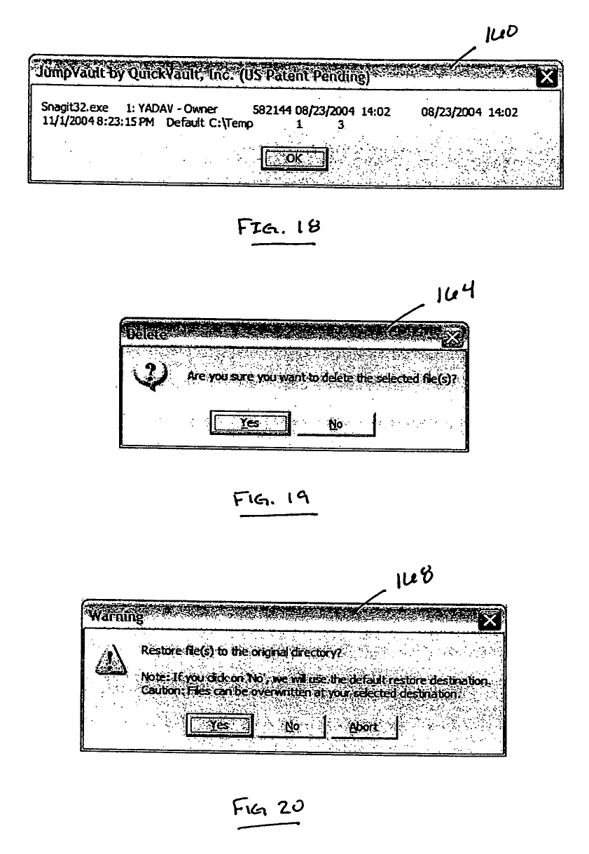

A restore selected files button 159 may also be provided which causes the explorer utility to perform a “partial restore.” A partial restore does not require that every file in a setup be restored to the computing device 20. A partial restore restores one or more files to the computing device 20 regardless of which setup the file(s) belong to. To restore a file from the explorer GUI 150, the user selects one or more of the left-most column fields 155 to select one or more files and clicks the restore selected files button 159. The user may be presented with a destination GUI 168, as shown in FIG. 20, which allows the user to restore the designated files to their original location on the computing device 20 or to the default destination previously entered by the user via the options menu item 85 (FIG. 7) and the preferences GUI 200 (FIG. 24) (described below) or via the restore destination field 146 on the restore GUI 140 (FIG. 16).

The explorer GUI 150 may also include a maximize explorer button 162 for maximizing the explorer GUI 150 window so that the contents of the spreadsheet 152 may be more easily viewed.

In other embodiments, the explorer utility may be configured to notify the user, such as by highlighting or sorting, when the same file name has been used for more than one file stored in the nonvolatile memory 15. In still other embodiments, the explorer utility may be configured to allow the user to search for files stored in the nonvolatile memory 15 by file name, created/modified date, folder, or other attributes using a find function.

Log Utility.

In accordance with another embodiment of the present invention, the application 16 comprises a log utility for tracking and displaying historical information relating to the backup and restore operations. With reference to FIG. 21, the log utility includes a log GUI 170 which is accessible by the user via a log button 171.

The log GUI 170 comprises a backup history spreadsheet 172 which functions in a manner similar to a spreadsheet utility, such as Microsoft Excel, in that the user may sort cells 173 of data by clicking on column headers 174. Further, the user may select one or more rows of the backup history spreadsheet 172 by selecting one or more left-most column fields 175.

The log GUI 170 also comprises a restore history spreadsheet 182 which functions in a manner similar to a spreadsheet utility, such as Microsoft Excel, in that the user may sort cells 183 of data by clicking on column headers 184. Further, the user may select one or more rows of the restore history spreadsheet 182 by selecting one or more left-most column fields 185.

The backup history spreadsheet 172 and the restore history spreadsheet 182 provide the user with information relating to previously executed backup and restore operations, respectively.

Specifically, the backup history spreadsheet 172 displays the setup name, the start date and time, the end date and time, and the backup type for each backup operation run by the backup utility. Backup types may include: (1) backup now—a backup operation executed through the backup GUI 130 (FIG. 14) using the backup now button 137 and (2) scheduled—a backup operation that was scheduled by the user using the schedule GUI 110 (FIGS. 10 and 1) and executed automatically by the application 16 at the scheduled instance. A view missed backup files button 176 may also be provided which, upon selection, displays a failed backup files GUI 190 as shown in FIG. 22. The failed backup files GUI 190 provides information relating to files that were included in an attempted backup operation but were not successfully stored in the nonvolatile memory 15.

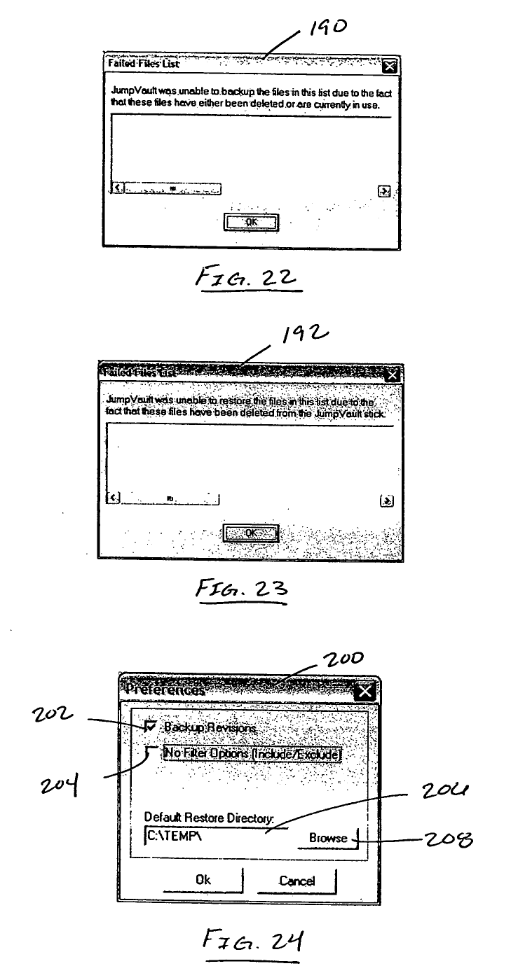

Similarly, the restore history spreadsheet 182 displays the start date and time, the end date and time, and the restore type for each restore operation executed by the restore utility. Restore types may include: (1) partial—a restore operation executed through the explorer GUI 150 (FIG. 17) using the restore selected files button 159 and (2) revision—a restore operation executed through the restore GUI 140 (FIG. 16) using the restore now button 149. A view missed restore files button 186 may also be provided which, upon selection, displays a failed restore files GUI 192 as shown in FIG. 23. The failed restore files GUI 192 provides information relating to files that were included in an attempted restore operation but were not successfully restored to the computing device 20.

Options Settings.

In accordance with another embodiment of the present invention, the application 16 comprises option settings which allow the user to designate preferences relating to backup and restore functionality, to password protection functionality, and to resetting the application to a default functionality.

With reference to FIG. 24, a preferences GUI 200 is accessible via a options menu item 85 (FIG. 7). The preferences GUI 200 includes a backup revisions field 202 that, when selected, causes the application 16 to track each backup operation for any specific setup. A no filter options field 204 is also provided which allows the user to turn off any previously configured file filtering settings. The preferences GUI 200 also allows the user to designate the default destination for storing restored files on the computing device 20 by entering a specific location into a default directory field 206 or by browsing the memory contents of the computing device 20 and selecting a location via a browse button 208.

With reference to FIGS. 5 and 6, the create password GUI 62 and the change password GUI 68 are accessible via the options menu item 85 (FIG. 7) for creating, changing, and disabling the password functionality for the application 16, as previously described.

With reference to FIG. 25, a reset GUI 220 is also accessible via the options menu item 85 (FIG. 7) for resetting the application 16 to factory default settings. Selecting this option will erase all of the backed up files stored in the nonvolatile memory 15 and reset the user's preferences to default factory settings.

Warnings Utility.

In accordance with another embodiment of the present invention, the application 16 comprises a warnings utility for providing the user with various notifications. Such notifications may be provided when: (1) the user attempts to designate a system file for a backup operation; (2) the user attempts to designate a file for a backup operation that is currently in use; (3) the user attempts to designate files having a total size greater than the available storage capacity in the nonvolatile memory 15; (4) the user attempts to designate a temporary file for a backup operation; (5) an overlapping operation is attempted; (6) the total size of the files stored in the nonvolatile memory 15 equals a threshold percentage of the total storage capacity of the nonvolatile memory 15; (7) the log file exceeds its initial allocation size; (8) multiple users are associated with the same computing device 20; and/or (9) the application has been in operation for a significant amount of time (which may influence the user to change his or her operation schedule).

Security.

In accordance with one embodiment of the present invention, various means for security are provided, such as: (1) providing a user ID for each user of the computing device 20 and/or the device 10; (2) providing an encrypted password for compressed files; (3) providing an encrypted computing device 20 identification key; (4) encrypting the data stored in the relational database 13; (5) providing a device 10 identification encryption utility; (6) encrypting folder and file names; and/or (7) encrypting the database schemas. In certain embodiments, the user may change one or more of the encryption keys provided by the device 10.

In other embodiments of the invention, two levels of encryption are offered: (1) standard encryption—the manufacturer/service provider supplies an internal transparent encryption key; and (2) user supplied encryption—the manufacturer/service provider accepts an encryption key supplied by the user.

In still other embodiments, encryption exists in the following locations and functions:
LOGON ID Encryption
   Compressed Filename Encryption
      Compressed File Password Encryption
         DB TBL DATA Encryption
            Stick ID Encryption
            Folder Name Encryption

The application 16 of the present invention is preferably compatible with the Windows 2000, NT, and XP operating systems. In other embodiments, the application 16 compatible with other major operating systems, such as MacOS 10, Linux, and Windows 98.

To achieve high portability, the present invention is self-contained with no dependencies on underlying operating systems functions (for example, the invention will not use Microsoft Foundation Classes). The invention is statically linked. Implementation language is compiled for fast performance and allows for code reuse (e.g., C++).

The software application 16 used by the invention may be modularized starting with the core application (with USB support enabled) and further comprising modules for an embedded database (e.g., sqlite), an encryption utility (e.g., dsEncryption/Blowfish), a compression utility (e.g., bzip2), a secure network support (e.g., a zlib variant), precision timing, and a portable GUI interface (e.g., xWindows/Posix library).

The present invention may use libraries freely available in the public domain, such as those distributed under Berkeley Software Distribution (“BSD”) style licensing schemes or under the Lesser GNU General Public License (“GPL”), that allow the use of such libraries in commercial products.

The compression utility of the present invention has a fast and high compression rate, a fast decompression algorithm, and is robust enough to allow for recovery (decompression) of partly damaged (compressed) files.

The encryption used in the present invention may be implemented via symmetric password based encryption (e.g., PBE) or other means.

The embedded SQL engine of the present invention is fast, self-contained, has very low overhead, and is be able to support ‘transactions.’ The SQL engine is also able to support terabytes of data (e.g., SQL LITE).

The present invention provides secure TCP sockets (e.g., SSL protocol) for remote backup (on-demand remote storage) support.

The present invention is able to support and recognize file permissions and is flexible enough to support multiple users and multiple settings, flexible backup scheduling, and has the ability to allow users to enable/disable encryption or compression and use local (e.g., USB, local hard drive, floppy, CD-RW) or remote storage (e.g., RapidNAS) media.

The present invention may contain a module that securely deletes files and allows total overwrite of deleted data.

The present invention may have an SMTP/email module for remote email notification of backup/encryption/deletion results/stats.

The encryption module of the present invention may provide the ability to encrypt/decrypt using biometrics (e.g., a USB fingerprint scanner) and password.

Database Schemas.

Identity Tables

PC Identity Table.

UNIQUE_ID (KEY FIELD-AUTOGEN-ALPHA NUMERIC)
MAC_ADDRESS (VARCHAR)
OS_NUMBER (VARCHAR)
OS_TYPE
COMP_NAME (VARCHAR)
ENCRYPTION (YES/NO)
COMPRESSION (YES/NO)
SESSION_TRANSID (NUM)
DTTM_STAMP (DATETIME)
FILE_COUNT (NUM)
TOTAL_SIZE (NUM)
USERFIELD 1
USERFIELD 2
USERFIELD 3
COMMENTS (NVARCHAR)

Software Version & Update Table.

UNIQUE_ID (KEY FIELD-AUTOGEN-ALPHA NUMERIC)
DTTM_STAMP (DATETIME)
VERSION NUMBER
SOURCE (INTERNET, CD, ETC.)
USERFIELD 4
USERFIELD 5
USERFIELD 6

Owner Registration Table.

UNIQUE_ID (KEY FIELD-AUTOGEN-ALPHA NUMERIC)
DTTM_STAMP (DATETIME)
LAST NAME
FIRST NAME
ADDRESS 1
ADDRESS 2
CITY
STATE
ZIPCODE
USERFIELD 7
USERFIELD 8
USERFIELD 9

Configuration Tables

PC Backup Schedule Table.

UNIQUE_ID (KEY FIELD-AUTOGEN-ALPHA NUMERIC)
DTTM_STAMP (DATETIME)
SCHEDULE_SEQUENCE_NUMBER
SCHEDULE_NAME
SCHEDULE (DAILY, WEEKLY, MONTHLY, ONCE,
AT PNP, AT LOGIN)
DAILY (FILLER)
DAILY_START_DATE
DAILY_END_DATE
DAILY_START_TIME_NUMERIC
DAILY_START_TIME_NUMERIC_AM_PM
EVERY_X_DAYS
WEEKLY(FILLER)
WEEKLY_START_DATE
WEEKLY_END_DATE
WEEKLY_START_TIME_NUMERIC
WEEKLY_START_TIME_NUMERIC_AM_PM
WEEKLY_DAY-OF_WEEK
MONTHLY
MONTHLY_START_DATE
MONTHLY_END_DATE
MONTHLY_START_TIME_NUMERIC
MONTHLY_START_TIME_AM_PM
MONTHLY_DAY_NUMERIC
MONTHLY_DAY_OF_WEEK_OCCURRENCE
MONTHLY_DAY_OF_WEEK
MONTHLY_BACKUP_IN_JANUARY
MONTHLY_BACKUP_IN_FEBRUARY
MONTHLY_BACKUP_IN_MARCH
MONTHLY_BACKUP_IN_APRIL
MONTHLY_BACKUP_IN_MAY
MONTHLY_BACKUP_IN_JUNE
MONTHLY_BACKUP_IN_JULY
MONTHLY_BACKUP_IN_AUGUST
MONTHLY_BACKUP_IN_SEPTEMBER
MONTHLY_BACKUP_IN_OCTOBER
MONTHLY_BACKUP_IN_NOVEMBER
MONTHLY_BACKUP_IN_DECEMBER
ONCE
ONCE_START_DATE
ONCE_END_DATE
ONCE_START_TIME_NUMERIC
ONCE_START_TIME_AM_PM
ONCE_DATE
PNP
PNP_START_DATE
PNP_END_DATE
LOGIN
LOGIN_START_DATE
LOGIN_END_DATE

PC Backup Target Table.

UNIQUE_ID (KEY FIELD-AUTOGEN-ALPHA NUMERIC)
ADD_DTTM_STAMP (DATETIME)
SCHEDULE_SEQUENCE_NUMBER
SCHEDULE_NAME
FOLDER_NAME
FILE_NAME
FILE_EXTENSION_NAME
ACTIVE_INACTIVE_FLAG
INACTIVE_FLAG_DTTM_STAMP (DATETIME)

PC Configuration Log Table.

UNIQUE_ID (KEY FIELD-AUTOGEN-ALPHA NUMERIC)
DTTM_STAMP (DATETIME)
OPERATION_CODE
TABLE_NAME
OLD_DATA
NEW_DATA

Activity Tables

PC Backup Log Table.

UNIQUE_ID (KEY FIELD-AUTOGEN-ALPHA NUMERIC)
DTTM_STAMP (DATETIME)
SCHEDULE_SEQUENCE_NUMBER
SCHEDULE_NAME
TOTAL_BYTES
ZIP_FILE_NAME
LOCATION
START_TIME
END_TIME

PC Backup File Log Table.

UNIQUE_ID (KEY FIELD-AUTOGEN-ALPHA NUMERIC)
DTTM_STAMP (DATETIME)
SCHEDULE_SEQUENCE_NUMBER
SCHEDULE_NAME
OPERATION_CODE
FOLDER_NAME
FILE_NAME
FILE_EXTENSION_NAME
SIZE_IN_BYTES
COMPRESSION_PERCENT
CREATE_DATE
LAST_MODIFIED_DATE

PC File Retrieval Log Table.

UNIQUE_ID (KEY FIELD-AUTOGEN-ALPHA NUMERIC)
DTTM_STAMP (DATETIME)
SCHEDULE_SEQUENCE_NUMBER
SCHEDULE_NAME
OPERATION_CODE
FOLDER_NAME
FILE_NAME
FILE_EXTENSION_NAME
SIZE_IN_BYTES
COMPRESSION_PERCENT
CREATE_DATE
LAST_MODIFIED_DATE

PC Error Log Table.

UNIQUE_ID (KEY FIELD-AUTOGEN-ALPHA NUMERIC)
DTTM_STAMP (DATETIME)
ERROR_CODE
INTERNALFIELD1
INTERNALFIELD2
INTERNALFIELD3
INTERNALFIELD4
INTERNALFIELD5
INTERNALFIELD6
INTERNALFIELD7

PC PNP Log Table.

UNIQUE_ID (KEY FIELD-AUTOGEN-ALPHA NUMERIC)
DTTM_STAMP (DATETIME)
START_TIME_OF_PNP
END_TIME_OF_PNP

PC Remote Download File Log Table.

UNIQUE_ID (KEY FIELD-AUTOGEN-ALPHA NUMERIC)
DTTM_STAMP (DATETIME)
OPERATION_CODE
FOLDER_NAME
FILE_NAME
FILE_EXTENSION_NAME
ZIP_FILE_NAME
SIZE_IN_BYTES
COMPRESSION_PERCENT
CREATE_DATE
LAST_MODIFIED_DATE

PC Hot Key Log Table.

UNIQUE_ID (KEY FIELD-AUTOGEN-ALPHA NUMERIC)
DTTM_STAMP (DATETIME)
SCHEDULE_SEQUENCE_NUMBER
SCHEDULE_NAME
OPERATION_CODE
FOLDER_NAME
FILE_NAME
FILE_EXTENSION_NAME
SIZE_IN_BYTES
COMPRESSION_PERCENT
CREATE_DATE
LAST_MODIFIED_DATE

Having thus described the invention in detail, it should be apparent that various modifications and changes may be made without departing from the spirit and scope of the present invention. Consequently, these and other modifications are contemplated to be within the spirit and scope of the following claims.

1. An apparatus for backing up files from a computing device comprising:
a. a portable housing;
b. nonvolatile memory within the housing;
c. an interface on the housing for communication between the nonvolatile memory and the computing device; and
d. a software application in the nonvolatile memory comprising a setup utility and a backup utility;
wherein the setup utility is configured to accept input via a setup graphical user interface to designate at least one file or data set on the computing device; and
wherein the backup utility is configured to make a copy of the at least one designated file or data set and store the copy of the at least one designated file or data set in the nonvolatile memory.

2. An apparatus as defined in claim 1, wherein the interface is a universal serial bus connector.

3. An apparatus as defined in claim 1, wherein the at least one designated file or data set comprises at least one folder or directory.

4. An apparatus as defined in claim 1, wherein the setup utility is further configured to accept input via the setup graphical user interface to filter a plurality of files or data sets on the computing device for designation based on type or attribute.

5. An apparatus as defined in claim 1, wherein the backup utility is further configured to, upon establishment of communication between the nonvolatile memory and the computing device, automatically make a copy of the at least one designated file or data set and automatically store the copy of the at least one designated file or data set in the nonvolatile memory.

6. An apparatus as defined in claim 1, wherein:
a. the setup utility is further configured to accept input via the setup graphical user interface to designate at least one file or data set on a second computing device; and
b. wherein the backup utility is further configured to make a copy of the at least one designated file or data set from the second computing device and store the copy of the at least one designated file or data set from the second computing device in the nonvolatile memory.

7. An apparatus as defined in claim 6, wherein the backup utility is further configured to, upon establishment of communication between the nonvolatile memory and the second computing device, automatically make a copy of the at least one designated file or data set from the second computing device and automatically store the copy of the at least one designated file or data set from the second computing device in the nonvolatile memory.

8. An apparatus as defined in claim 6, wherein the backup utility is further configured to:
a. associate the stored copy of the at least one designated file or data set from the first computing device with the first computing device; and
b. associate the stored copy of the at least one designated file or data set from the second computing device with the second computing device.

9. An apparatus as defined in claim 1, wherein the software application further comprises a restore utility, and wherein the restore utility is configured to:
a. accept input via a restore graphical user interface to designate at least one file or data set on the nonvolatile memory; and
b. make a copy of the at least one designated file or data set from the nonvolatile memory and store the copy of the at least one designated file or data set on the computing device.

10. An apparatus as defined in claim 9, wherein designating at least one file or data set on the nonvolatile memory includes designating at least one of a plurality of versions of a file or data set.

11. An apparatus as defined in claim 9, wherein the restore utility is further configured to:
a. accept input via the restore graphical user interface to designate a second at least one file or data set on the nonvolatile memory; and
b. make a copy of the second at least one designated file or data set from the nonvolatile memory and store the copy of the second at least one designated file or data set on a second computing device.

12. An apparatus as defined in claim 1:
a. wherein the setup utility is further configured to accept input via the setup graphical user interface to designate a regular interval; and
b. wherein the backup utility is further configured to, at a plurality of instances separated by the regular interval, automatically make a copy of the at least one designated file or data set from the computing device and automatically store the copy of the at least one designated file or data set in the nonvolatile memory.

13. An apparatus as defined in claim 12, wherein the regular interval is selected from the group consisting of one day, one week, and one month.

14. An apparatus as defined in claim 12, wherein the backup utility is further configured to:
a. determine when a copy of the at least one designated file or data set from the computing device was not made at one of the instances; and
b. upon establishment of communication between the nonvolatile memory and the computing device, automatically make a copy of the at least one designated file or data set and automatically store the copy of the at least one designated file or data set in the nonvolatile memory when a copy of the at least one designated file or data set from the computing device was not made at one of the instances.

15. An apparatus as defined in claim 1, wherein the backup utility is further configured to:
a. determine the size of the at least one designated file or data set;
b. determine the remaining storage capacity of the nonvolatile memory; and
c. provide a notification when the size of the at least one designated file or data set is greater than the remaining storage capacity of the nonvolatile memory.

16. An apparatus as defined in claim 1:
a. wherein the setup utility is further configured to accept input via the setup graphical user interface to group the designated at least one file or data set into a batch; and
b. wherein the backup utility is further configured to make a copy of each of the designated at least one file or data set in the batch from the computing device and store the copy of each of the designated at least one file or data set in the batch in the nonvolatile memory.

17. An apparatus as defined in claim 1, wherein the software application further comprises a compression utility, and wherein the compression utility is configured to:
a. compress the copy of the at least one designated file or data set to produce a compressed file; and
b. store the compressed file in the nonvolatile memory.

18. An apparatus as defined in claim 17, wherein the software application further comprises a restore utility and a decompression utility, and
a. wherein the restore utility is configured to accept input via a restore graphical user interface to designate at least one compressed file in the nonvolatile memory and make a copy of the designated at least one compressed file from the nonvolatile memory; and
b. wherein the decompression utility is configured to decompress the copy of the at least one compressed file to produce a decompressed file and store the decompressed file on the computing device.

19. An apparatus as defined in claim 1, wherein the nonvolatile memory further comprises a relational database for storing attributes of the designated at least one file or data set.

20. An apparatus as defined in claim 19, wherein the software application further comprises an encryption utility, and wherein the encryption utility is configured to encrypt the attributes of the designated at least one file or data set that are stored in the relational database.

21. An apparatus as defined in claim 1, wherein the software application further comprises a security utility, and wherein the security utility is configured to:
a. accept input via a password graphical user interface to define a first password;
b. store the first password in the nonvolatile memory;
c. accept input via the password graphical user interface to verify the identity of a user and define a second password; and
d. prevent execution of the software application if the second password is not equal to the first password.

22. A method for backing up files from a computing device comprising the steps of:
a. establishing communication between the computing device and a nonvolatile memory via an interface;
b. accepting input via a setup graphical user interface of a software application to designate at least one file or data set on the computing device; and
c. using the software application to make a copy of the at least one designated file or data set and store the copy of the at least one designated file or data set in the nonvolatile memory;
wherein the nonvolatile memory is within a portable housing; and
wherein the software application is in the nonvolatile memory.

23. A method as defined in claim 22, wherein the interface is a universal serial bus connector.

24. A method as defined in claim 22, wherein the at least one designated file or data set comprises at least one folder or directory.

25. A method as defined in claim 22, further comprising the step of accepting input via the setup graphical user interface to filter a plurality of files or data sets on the computing device for designation based on type or attribute.

26. A method as defined in claim 22, further comprising the steps of:
a. automatically making a copy of the at least one designated file or data set upon establishment of communication between the nonvolatile memory and the computing device; and
b. automatically storing the copy of the at least one designated file or data set in the nonvolatile memory.

27. A method as defined in claim 22, further comprising the steps of:
a. accepting input via the setup graphical user interface to designate at least one file or data set on a second computing device; and
b. using the software application to make a copy of the at least one designated file or data set from the second computing device and store the copy of the at least one designated file or data set from the second computing device in the nonvolatile memory.

28. A method as defined in claim 27, further comprising the steps of:
a. automatically making a copy of the at least one designated file or data set from the second computing device upon establishment of communication between the nonvolatile memory and the computing device; and
b. automatically storing the copy of the at least one designated file or data set from the second computing device in the nonvolatile memory.

29. A method as defined in claim 27, further comprising the steps of:
a. associating the stored copy of the at least one designated file or data set from the first computing device with the first computing device; and
b. associating the stored copy of the at least one designated file or data set from the second computing device with the second computing device.

30. A method as defined in claim 22, further comprising the steps of:
a. accepting input via a restore graphical user interface of the software application to designate at least one file or data set on the nonvolatile memory; and
b. using the software application to make a copy of the at least one designated file or data set from the nonvolatile memory and store the copy of the at least one designated file or data set on the computing device.

31. A method as defined in claim 30, wherein designating at least one file or data set on the nonvolatile memory includes designating at least one of a plurality of versions of a file or data set.

32. A method as defined in claim 30, further comprising the steps of:
a. accepting input via the restore graphical user interface to designate a second at least one file or data set on the nonvolatile memory; and
b. using the software application to make a copy of the second at least one designated file or data set from the nonvolatile memory and store the copy of the second at least one designated file or data set on a second computing device.

33. A method as defined in claim 22, further comprising the steps of:
a. accepting input via the setup graphical user interface to designate a regular interval; and
b. at a plurality of instances separated by the regular interval, automatically making a copy of the at least one designated file or data set from the computing device and automatically storing the copy of the at least one designated file or data set in the nonvolatile memory.

34. A method as defined in claim 33, wherein the regular interval is selected from the group consisting of one day, one week, and one month.

35. A method as defined in claim 33, further comprising the steps of:
a. determining when a copy of the at least one designated file or data set from the computing device was not made at one of the instances; and
b. upon establishment of communication between the nonvolatile memory and the computing device, automatically making a copy of the at least one designated file or data set and automatically storing the copy of the at least one designated file or data set in the nonvolatile memory when a copy of the at least one designated file or data set from the computing device was not made at one of the instances.

36. A method as defined in claim 22, further comprising the steps of:
a. determining the size of the at least one designated file or data set;
b. determining the remaining storage capacity of the nonvolatile memory; and
c. providing a notification when the size of the at least one designated file or data set is greater than the remaining storage capacity of the nonvolatile memory.

37. A method as defined in claim 22, further comprising the steps of:
a. accepting input via the setup graphical user interface to group the designated at least one file or data set into a batch; and
b. making a copy of each of the designated at least one file or data set in the batch from the computing device and storing the copy of each of the designated at least one file or data set in the batch in the nonvolatile memory.

38. A method as defined in claim 22, further comprising the steps of:
a. compressing the copy of the at least one designated file or data set to produce a compressed file; and
b. storing the compressed file in the nonvolatile memory.

39. A method as defined in claim 38, further comprising the steps of:
a. accepting input via a restore graphical user interface of the software application to designate at least one compressed file in the nonvolatile memory;
b. making a copy of the designated at least one compressed file from the nonvolatile memory;
c. decompressing the copy of the at least one compressed file to produce a decompressed file; and
d. storing the decompressed file on the computing device.

40. A method as defined in claim 22, further comprising the step of storing attributes of the designated at least one file or data set in a relational database.

41. A method as defined in claim 40, further comprising the step of encrypting the attributes of the designated at least one file or data set that are stored in the relational database.

42. A method as defined in claim 41, further comprising the step of decrypting and displaying the attributes of at least one designated file or data set via an explorer graphical user interface of the application.

43. A method as defined in claim 22, further comprising the steps of:
a. accepting input via a password graphical user interface of the software application to define a first password;
b. storing the first password in the nonvolatile memory;
c. accepting input via the password graphical user interface to verify the identity of a user and define a second password; and
d. preventing execution of the application if the second password is not equal to the first password.

44. A method as defined in claim 43, further comprising the steps of:
a. associating the first password with the computing device;
b. accepting input via the password graphical user interface of the software application to define a third password;
c. storing the third password in the nonvolatile memory;
d. associating the third password with a second computing device;
e. accepting input via the password graphical user interface to verify the identity of a user and define a fourth password; and
f. preventing execution of the application when the nonvolatile memory is in communication with the second computing device if the fourth password is not equal to the third password.

45. A method as defined in claim 43, further comprising the step of accepting input via the password graphical user interface to change the first password.

46. A method as defined in claim 22, further comprising the step of loading the software application into the nonvolatile memory.
